(19) United States
(12) Patent Application Publication
(10) Pub. No.: US 2005/0271286 A1
(43) Pub. Date: Dec. 8, 2005

(54) Method and encoder for coding a digital video signal

(75) Inventors: Gwenaelle Marquant, Liffre (FR); Joel Jung, Guyancourt (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Ba Eindhoven (NL)

(21) Appl. No.: 10/521,708

(22) PCT Filed: Jul. 9, 2003
(86) PCT No.: PCT/IB03/03062

§ 371 Date: Jan. 19, 2005

(30) Foreign Application Priority Data
Jul. 24, 2002 (EP) 02291873.4

(51) Int. Cl. G06K 9/36; G06K 9/46

(52) U.S. Cl. 382/236

(57) ABSTRACT

The present invention relates to a method and an encoder for coding an input digital video signal comprising a luminance component with luminance values. The method comprises the steps of:- transforming said video sequence from the original spatial representation into fewer representation data comprising transformed luminance values;—performing a quantization on the representation data so as to obtain a reduced set of data. The invention is characterized in that the quantization step performs a quantization of the luminance component in an adaptive way according to a visible range of transformed luminance values of the luminance component.

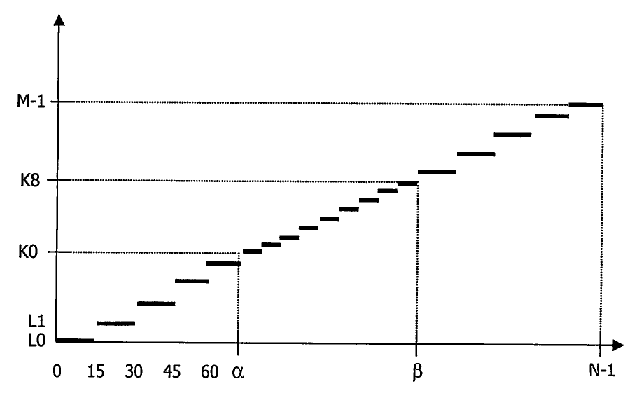

### FIELD OF THE INVENTION

The present invention relates to a method for coding an input digital video sequence corresponding to a color image sequence comprising a luminance component with luminance values, and having a spatial representation, said method comprising the following steps:
a transformation step, provided for transforming said video sequence from the original spatial representation domain into fewer representation data comprising transformed luminance values;
a quantization step, provided for performing a quantization on the representation data so as to obtain a reduced set of data.

The invention also relates to an encoder, said encoder implementing said method.

Such a method may be used in, for example, a video communication system.

### BACKGROUND OF THE INVENTION

A video communication system, like for example a television communication system, typically comprises an encoder, a transmission medium and a decoder. Such a system receives an input digital video sequence corresponding to an original color image sequence, encodes said sequence via the encoder, transmits the encoded sequence also called bit stream via the transmission medium, and then decodes the transmitted sequence via the decoder resulting in an output digital video sequence.

The input digital video sequence has an associated spatial representation. In classical video approaches, a spatial representation comprises 3 different components: luminance Y, chrominance U and chrominance V. The luminance component is represented by different gray levels, in general 256 gray levels.

In order to transmit only the necessary information of the digital video sequence, the encoder reduces the spatial representation into fewer representation data and then performs a quantization of this reduced representation data.

In order to improve the rate/distortion ratio, that is to say the bits rate used for encoding versus the distortion perceived in the decoded image sequence from the original image sequence, several quantization solutions have already been proposed in the prior art.

One of them is described in the document referenced “H. G. Mussmann, P. Pirsch and H-J Grallert “Advances in picture coding” in the IEEE proceedings, vol. 73, N^{o}.4, 523-548 April 1985”. The solution of the prior art is based on activity measures using activity functions. A typical example of activity function is to compute the maximum difference between neighboring pixels within an area of an image sequence. If the maximum is lower than a threshold value, it means that there are some homogeneous luminance values within this area, and then this area is considered as having no activity. By means of more complex activity functions, an image sequence can be divided into several segments, on which different quantizations are performed. In this case, an adaptive quantizer can be realized by a set of separate sub-quantizers, one for each segment, with which some specific activity values are associated.

All of these quantization solutions minimize the distortion of an image on average, over all original values of said image. Thus, they propose to have few or no reproduction values in locations at which the probability of appearance of gray levels, for example, within the video signal is negligible, whereas at high probability of appearance of gray levels, more reproduction points need to be specified.

Given that the aim of image coding is to reconstruct an input image with the best possible visual quality, one major inconvenience of these solutions of the prior art is that they result only in an approximate fit to the perceptual response of the human eye.

### OBJECT AND SUMMARY OF THE INVENTION

Accordingly, it is an object of the invention to provide a method and an encoder for coding an input digital video sequence corresponding to a color image sequence comprising a luminance component with luminance values, and having a spatial representation, as defined in the preamble of claim 1, which improve the visual quality of the reconstructed input digital video sequence with a good rate/distortion.

To this end, the quantization step of the method performs a quantization of the luminance component in an adaptive way according to a visible range of transformed luminance values of said luminance component in order to obtain said reduced set of data.

In addition, the quantization means within the encoder are adapted to perform a quantization of the luminance component in an adaptive way according to a visible range of transformed luminance values of said luminance component in order to obtain said reduced set of data.

As we will see in detail further below, the invention is based on the recognition that under standard viewing conditions, human eyes cannot distinguish some transformed luminance values in certain ranges. Therefore, with this principle, the quantization step will be adapted in accordance with the perceptual properties of the human eye, and more particularly to said visible range.

### BRIEF DESCRIPTION OF THE DRAWINGS

Additional objects, features and advantages of the invention will become apparent upon reading the following detailed description and upon reference to the accompanying drawings in which the Figure illustrates how a quantization can be performed on transformed luminance values within or outside a visible range by the encoder according to the invention.

### DETAILED DESCRIPTION OF THE INVENTION

In the following description, functions or constructions that are well-known to the person skilled in the art are not described in detail, because they would obscure the invention in unnecessary detail.

The present invention relates to a method of coding an input digital video sequence corresponding to an original color image sequence comprising a luminance component with luminance values, said method being used in particular in an encoder within a video communication system. Said system receives some digital video sequences.

In order to efficiently transmit the input video sequences through a transmission medium, said encoder applies an encoding. Said encoding sequences known as bit stream are sent to a decoder, which decodes and reconstructs the original video sequences.

It is to be noted that the spatial representation data is often a YUV luminance and chrominance representation well known to the person skilled in the art, with the luminance component being represented by 256 gray levels.

Such an encoder comprises:
transformation means for transforming said video sequence from an original spatial representation domain into fewer representation data comprising transformed luminance values;
quantization means for performing a quantization on the representation data, thus obtaining a reduced set of data; and
encoding means for coding said reduced set of data.

An input digital video sequence is encoded as follows.

In a first step 1) the original spatial representation data, i.e. the YUV luminance and chrominance representation, is transformed into a less representation data, for example in a frequency domain by a DCT transform or by mesh method well known to the person skilled in the art. This less representation data leads to transformed luminance and chrominance values.

More particularly for the luminance component, this leads to a reduction of a set of data of 256 gray levels coded on 8 bits into corresponding DC and AC coefficients, if for example a DCT transform is used, said DCT transform being used on blocks of an image sequence.

The DC coefficient of a block is the mean value of the luminance values of said block. Hence, this DC coefficient represents a transformed luminance value. For other transforms than the DCT one, the same parallel can be applied.

Perceptual studies have already shown that, under standard viewing conditions, human eyes cannot distinguish small luminance variations (from 1 to 5 gray levels).

Moreover, perceptual tests performed by the applicant show that, for a luminance component including 256 gray levels (from 0 to 255 for example), human eyes are more sensitive to luminance changes inside the luminance range [70; 130] than in the range [0; 70] or in the range [130 ; 255]. The first range is called the visible range.

The luminance values and the transformed luminance values that can be perceived correctly by human eyes are called relevant values and relevant transformed values, respectively, whereas the other are called non-relevant values and non-relevant transformed values, respectively.

Therefore, in a second step 2), a quantization is performed on the reduced set of data, more particularly a quantization is performed on the transformed luminance values of the luminance component and this in accordance with perceptual properties described above.

According to a first non-limitative embodiment, the quantization step performs a quantization on the luminance component by calculating the probability of appearance of transformed luminance values within the video sequence as previously mentioned in the prior art, but a heaviest weight of probability is applied first to the transformed luminance values, which are in the visible range. Thus, the transformed luminance values in the visible range will be taken into account in a more adequate way for the human eye than if there was only a common probability calculation applied. At the end, the less representation data is transformed into a reduced set of data according to said probability of appearance.

According to a second preferred embodiment, the quantization step performs a quantization on the luminance component by applying fine quantization points for the transformed luminance values in the visible range, whereas outside the range, coarse quantization points are used for the transformed luminance values.

In the example illustrated in the Figure, there are N transformed luminance values for the luminance component and M points are used for quantization.

If the visible range is [α,β], K quantization points K0 to K8 will be used to perform the quantization of the transformed luminance values in this range. Either one quantization point will be attributed to one transformed luminance value, or for example, one quantization point is attributed for a very small set of transformed luminance values, for 2 transformed luminance values, for example.

These K points can have exactly the same values of the corresponding transformed luminance values, while the dynamic of the luminance component dynamic is kept unchanged, or not. In the example, α=70, and β=130.

Outside the visible range, i.e. in the range [0,α] and in the range [β,N−1],L quantization points are used to perform the quantization of the transformed luminance values by intervals. For example, if the transformed luminance values are from 0 to 15, one quantization point L0 will be attributed to this interval. From 15 to 30, a second quantization point L1 will be attributed, etc. Hence, outside the visible range, the quantization is very coarse. Although the non-relevant transformed values of luminance are degraded, the human eye will not see any difference.

Thus, a unique quantization point outside the visible range is attributed to a big cluster of transformed luminance value, whereas a quantization point is attributed to one or a smaller cluster of transformed luminance values, which are in the visible range. Such a cluster in the visible range comprises far fewer transformed luminance values than a cluster outside the visible range.

Thus, the quantization of the luminance component has been done in an adaptive way, because it was not uniform for all the transformed luminance values, but one fine quantization has been performed for a certain range of luminance values, and a second coarse quantization has been performed for another range of luminance values.

In the last step), the reduced data obtained by the quantization representation is coded, for example by variable run-length coding well known to the person skilled in the art, which consists in associating some symbols with some series of values on which a quantization has been performed.

At the decoder side, the decoding is done to reconstruct the original image, taking into account the quantization points as described previously. The human eye will not see much distortion between the output image obtained and the original image.

Thus, one advantage of the present invention is to improve the rate/distortion by encoding more information with the same bit budget than the prior art, or less information with far fewer bits but without losing any quality in the encoding. Indeed, as a fme quantization is performed on all the relevant transformed values of luminance, the quality of the image is not lower. Moreover, the new representation of the image has been chosen to be such, as the reconstructed video signal perfectly matches the visual capacities of a human observer.

It is to be understood that the present invention is not limited to the aforementioned embodiments and variations and modifications may be made without departing from the spirit and scope of the invention as defined in the appended claims. In this respect, the following closing remarks are made.

It is to be noted that the quantization step described above according to the invention can also be applied directly on the luminance values of the spatial representation. But, practically, as for the video applications, there is always a compression, it will not often be applied directly but on the transformed luminance values only.

It is to be understood that the present invention is not limited to the aforementioned video application. It can be used within any application using a system for coding a digital video sequence where the ultimate consumer is the human eye, such as applications including digital movies, HDTV, and transmission and visualization of scientific imagery. Image codes have to be designed to match the visual capabilities of the human observer.

It is to be understood that the method according to the present invention is not limited to the aforementioned implementation.

There are numerous ways of implementing functions of the method according to the invention by means of items of hardware or software, or both, provided that a single item of hardware or software can carry out several functions. It does not exclude that an assembly of items of hardware or software or both carry out a function, thus forming a single function without modifying the method for coding the video signal in accordance with the invention.

Said hardware or software items can be implemented in several manners, such as by means of wired electronic circuits or by means of an integrated circuit that is suitably programmed. The integrated circuit may be incorporated in a computer or in an encoder. In the second case, the encoder comprises transformation means and quantization means, as described previously, said means being hardware or software items as stated above.

The integrated circuit comprises a set of instructions. Thus, said set of instructions contained, for example, in a computer programming memory or in an encoder memory may cause the computer or the encoder to carry out the different steps of the decoding method.

The set of instructions may be loaded into the programming memory by reading a data carrier such as, for example, a disk. A service provider can also make the set of instructions available via a communication network such as, for example, the Internet.

Any reference sign in the following claims should not be construed as limiting the claim. It will be obvious that the use of the verb “to comprise” and its conjugations does not exclude the presence of any other steps or elements besides those defined in any claim. The article “a” or “an” preceding an element or step does not exclude the presence of a plurality of such elements or steps.

1. A method for coding an input digital video sequence corresponding to a color image sequence comprising a luminance component with luminance values, and having a spatial representation, said method comprising the following steps:
a transformation step, provided for transforming said video sequence from the original spatial representation domain into fewer representation data comprising transformed luminance values;
a quantization step, provided for performing a quantization on the representation data so as to obtain a reduced set of data, characterized in that said quantization step performs a quantization of the luminance component in an adaptive way according to a visible range of transformed luminance values of said luminance component in order to obtain said reduced set of data.

2. A method for coding an input digital video sequence as claimed in claim 1, characterized in that the quantization step is performed by:
applying a heavy weight to the transformed luminance values in the visible range;
computing the probability of transformed luminance values appearance within the luminance component; and
transforming the representation data into said reduced set of data according to said probability of values appearance.

3. A method for coding an input digital video sequence as claimed in claim 1, characterized in that the quantization step is performed by:
using coarse quantization points for the transformed luminance values outside the visible range; and
using fine quantization points for the transformed luminance values within the visible range.

4. A computer program product for an encoder, comprising a set of instructions, which, when loaded into said encoder, causes the encoder to carry out the method as claimed in claims 1 to 3.

5. A computer program product for a computer, comprising a set of instructions, which, when loaded into said computer, causes the computer to carry out the method as claimed in claims 1 to 3.

6. An encoder for coding an input digital video signal corresponding to a color image sequence comprising a luminance component with luminance values, said signal having a spatial representation, said encoder comprising:
transformation means for transforming said video sequence from an original spatial representation domain into fewer representation data comprising transformed luminance values;
quantization means for performing a quantization on the representation data so as to obtain a reduced set of data, characterized in that said quantization means are adapted to perform a quantization of the luminance component in an adaptive way according to a visible range of transformed luminance values of said luminance component in order to obtain said reduced set of data.

7. A video communication system, which is able to receive an input digital video signal, said signal being coded by the encoder defined in claim 6.
